(19) United States
(12) Patent Application Publication
(10) Pub. No.: US 2023/0202824 A1
(43) Pub. Date: Jun. 29, 2023

(54) MANAGING DISPENSEMENT OF FLUID TO A RECEPTACLE

(71) Applicant: PepsiCo, Inc., Purchase, NY (US)

(72) Inventors: Kazim KHAN, Nanuet, NY (US); Dominic LACATENA, Stanhope, NJ (US); Neer PATEL, Paramus, NJ (US)

(21) Appl. No.: 17/564,887

(22) Filed: Dec. 29, 2021

(51) Int. Cl. B67D 1/08; G05B 17/02; G06V 20/50; G06V 10/764

(52) U.S. Cl. CPC B67D 1/0888; G05B 17/02; G06V 20/50; G06V 10/764

(57) ABSTRACT

Disclosed herein are system, method, and computer program product embodiments for using imaging data to manage the dispensement of fluid to a receptacle. Imaging data captured by a camera configured with a fluid dispenser may be used to control receptacle autofill operations for the fluid dispenser. An embodiment operates by receiving first imaging data that indicates a receptacle. Classification information that indicates empty and full states for the receptacle may be determined, for example, by a predictive model. The embodiment may cause fluid to start pouring into the receptacle based on an image of the first imaging data and the classification information indicating that the receptacle is in the empty state. The embodiment may receive second imaging data and cause the fluid to stop pouring into the receptacle based on an image of the second imaging data and the classification information indicating that the receptacle is in the full state.

### BACKGROUND

Fluid (e.g., beverage and/or ice) dispensers often require user interaction (e.g., direct or indirect contact with the dispenser, etc.), such as pushing a cup against an activation lever and/or the like, to initiate and/or terminate dispensing. User interaction with beverage dispensers to initiate the dispensement of a beverage can cause unsafe/unsanitary conditions due to the transfer of germs between a user's hand and/or cup and the activation lever. Germs transferred to an activation lever may migrate to nozzle openings of the beverage dispenser and multiply, thereby contaminating beverages (and/or ice) for future unsuspecting users. Fluid (e.g., beverage and/or ice) dispensers implementing conventional autofill technology, for example, such as fluid dispensers with virtual activation levers that start and stop dispensing when a virtual plane is broken by a cup, often operate inconsistently due to faulty and/or inaccurate sensor information. Inconsistent and/or inaccurate sensor information is often due to sensors failing and/or generating errors as a result of surrounding temperature changes and/or other environmental issues. Fluid dispensers implementing conventional autofill technology, for example, fluid dispensers with ultrasonic-based autofill technology, often operate inconsistently due to faulty and/or inaccurate sensor information as a result of ultrasonic signals ricocheting off of adjacent cups, spilled ice or beverages, and/or the like. Fluid dispensers implementing conventional autofill technology, such as virtual activation levers (and/or the like) and ultrasonic-based autofill technology, operate with indiscriminate detection of objects (e.g., cups vs. hands, etc.), resulting in overfilling or underfilling of a cup with a beverage (and/or ice). Overfilling a cup with a beverage (and/or ice) is often wasteful and messy. And underfilling a cup with a beverage (and/or ice) can be time-consuming and ruin a user experience.

### BRIEF DESCRIPTION OF THE DRAWINGS

The accompanying drawings, which are incorporated herein and form a part of the specification, illustrate the present disclosure and, together with the description, further serve to explain the principles thereof and to enable a person skilled in the pertinent art to make and use the same.

FIG. 1 shows an example system for using imaging data to manage the dispensement of fluid to a receptacle, according to some aspects.

FIG. 2 shows an example system for training an imaging module that may be used to manage the dispensement of fluid to a receptacle, according to some aspects.

FIG. 3 shows a flowchart of an example training method for generating a machine learning classifier to classify imaging data used to manage the dispensement of fluid to a receptacle, according to some aspects.

FIG. 4 shows a flowchart of an example method for using imaging data to manage the dispensement of fluid to a receptacle, according to some aspects.

FIG. 5 shows a flowchart of another example method for using imaging data to manage the dispensement of fluid to a receptacle, according to some aspects.

FIG. 6 shows a schematic block diagram of an exemplary computer system in which aspects described may be implemented.

### DETAILED DESCRIPTION

Provided herein are example systems, apparatuses, devices, methods, computer program product embodiments, and/or combinations and sub-combinations thereof for using imaging data to manage the dispensement of fluid to a receptacle. According to some aspects, an imaging device (e.g., a camera, etc.) may be positioned to capture imaging data (e.g., video, static images, etc.) of an area associated with a fluid dispenser (e.g., a beverage dispenser, a water dispenser, a fountain drink machine, etc.). For example, the field of view of the imaging device may capture imaging data from a perspective of a dispensing nozzle of a fluid dispenser. When a cup (or similar receptacle) is determined from the imaging data to be in proximity (e.g., beneath, etc.) the dispensing nozzle, a predictive model may classify the cup as being an empty cup (e.g., without fluid, etc.) or a full cup (e.g., with a set amount of fluid, etc.) . The imaging data may then be used to autofill the cup with fluid from the fluid dispenser.

Embodiments herein use imaging data to manage the dispensement of fluid to a cup (or a similar receptacle) provide various technological improvements over conventional systems. For example, conventionally, to operate a fluid dispenser (e.g., a beverage dispenser, a water dispenser, a fountain drink machine, etc.), a consumer may need to physically contact the device to dispense and/or retrieve a fluid, a beverage, a product, and/or the like. However, fluid dispensers and/or the like may carry germs as the result of multiple consumers contacting the devices. Consumers may choose not to use fluid dispensers and/or the like if they feel that the devices are not clean and sanitary and/or if they feel that they may encounter germs and become ill. Fluid (e.g., beverage and/or ice) dispensers implementing conventional autofill technology, for example, such as fluid dispensers with virtual activation levers that start and stop dispensing when a virtual plane is broken by a cup, often operate inconsistently due to faulty and/or inaccurate sensor information. Inconsistent and/or inaccurate sensor information is often due to sensors failing and/or generating errors as a result of surrounding temperature changes and/or other environmental issues. Fluid dispensers implementing conventional autofill technology, for example, fluid dispensers with ultrasonic-based autofill technology, often operate inconsistently due to faulty and/or inaccurate sensor information as a result of ultrasonic signals ricocheting off of adjacent cups, spilled ice or beverages, and/or the like. Fluid dispensers implementing conventional autofill technology, such as virtual activation levers (and/or the like) and ultrasonic-based autofill technology, operate with indiscriminate detection of objects (e.g., cups vs. hands, etc.), resulting in overfilling or underfilling of a cup with a beverage (and/or ice). Overfilling a cup with a beverage (and/or ice) is often wasteful and messy. And underfilling a cup with a beverage (and/or ice) can be time-consuming and ruin a user experience.

Embodiments herein solve these technological problems by using imaging data to manage the dispensement of fluid to a cup (or a similar receptacle) to enable contactless retrieval of fluid from a fluid dispenser. This can reduce and/or prevent the transfer of germs and/or the like while also curbing fluid overfilling or underfilling scenarios. These and other technological advantages are described herein

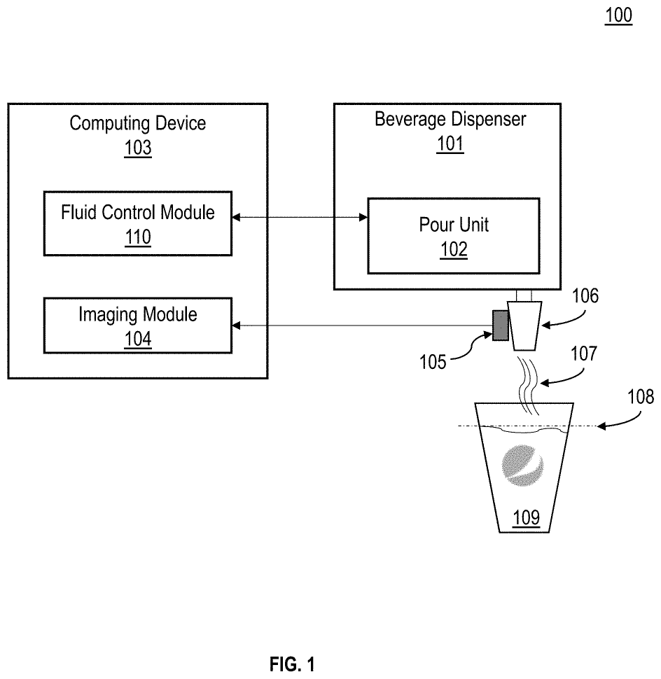

FIG. 1 shows a block diagram of an example system 100 for using imaging data to manage the dispensement of fluid to a receptacle, according to some aspects. System 100 may include a fluid dispenser 101, a computing device 103, and a receptacle 109.

The fluid dispenser 101 may incorporate and/or be configured with any number of components, devices, and/or the like conventionally incorporated and/or be configured with a fluid dispenser (e.g., a beverage dispenser, a water dispenser, a fountain drink machine, etc.) that, for simplicity, are not shown. For example, fluid dispenser 101 may include one or more supplies of concentrated beverage syrup attached to a syrup pump via tubing that passes through a cooling system (e.g., a chiller, a water bath, a cold plate, etc.) to a pour unit 102. The pour unit 102 may meter the flow rate of the syrup as delivered to a post-mix beverage dispensing nozzle 106. The fluid dispenser 101 may include a water line (e.g., connected to a water source) that provides water to a carbonator. Carbonated water from the carbonator may pass via tubing through the cooling system to pour unit 102. The pour unit 102 may include syrup and water flow rate controllers that operate to meter the flow rates of syrup and water so that a selected ratio of water and syrup is delivered to the beverage dispensing nozzle 106.

The computing device 103 may be in communication with the fluid dispenser 101. Communication between the computing device 103 and the fluid dispenser 101 may include any wired communication (e.g., fiber optics, Ethernet, coaxial cable, twisted pair, circuitry, etc.) and/or wireless communication technique (e.g., infrared technology, BLUETOOTH®, near-field communication, Internet, cellular, satellite, etc.). According to some aspects, the computing device 103 may be configured with and/or in proximity to the fluid dispenser 101. According to some aspects, the computing device 103 may be configured separate from and/or remotely from the fluid dispenser 101. The computing device 103 may send one or more signals (e.g., transmissions, requests, data, etc.) that control operations of the fluid dispenser 101, for example, such as, one or more signals that control when the pour unit 102 causes fluid to be dispensed from the beverage dispensing nozzle 106.

To facilitate control of when the pour unit 102 causes fluid to be dispensed from the beverage dispensing nozzle 106, the computing device 103 may include an imaging module 104. The imaging module 104 may include and/or be in communication with one or more image capturing devices, such as a camera 105, that captures imaging data (e.g., video, static images, etc.). The imaging module 104 may receive imaging data that provides a real-time and/or real-world representation of the receptacle 109. The imaging module 104 may receive imaging data depicting objects in the field of view of the camera 105 that provides a real-time and/or real-world representation of the receptacle 109. For example, imaging module 104 may receive imaging data that indicates when the receptacle 109 is positioned and/or placed beneath the beverage dispensing nozzle 106.

According to some aspects, the imaging module 104 may be configured to process the imaging data from the camera 105. The imaging module 104 may use artificial intelligence and/or machine learning, such as image recognition and/or object recognition, to identify objects depicted by one or more images of a plurality of images, such as video frames, static images, and/or the like, included with the imaging data. According to some aspects, the imaging module 104 may use one or more object identification and/or classification algorithms to determine/detect a state of the receptacle 109, such as whether the receptacle 109 contains fluid or not. According to some aspects, the imaging module 104 may use one or more object identification and/or tracking algorithms to determine/detect the locations of the landmarks in imaging data, for example, such as a fill line 108 (e.g., an indication of available fluid capacity, etc.) of the receptacle 109 and/or the amount and/or position of fluid 107 dispensed to the receptacle 109 by the beverage dispensing nozzle 106.

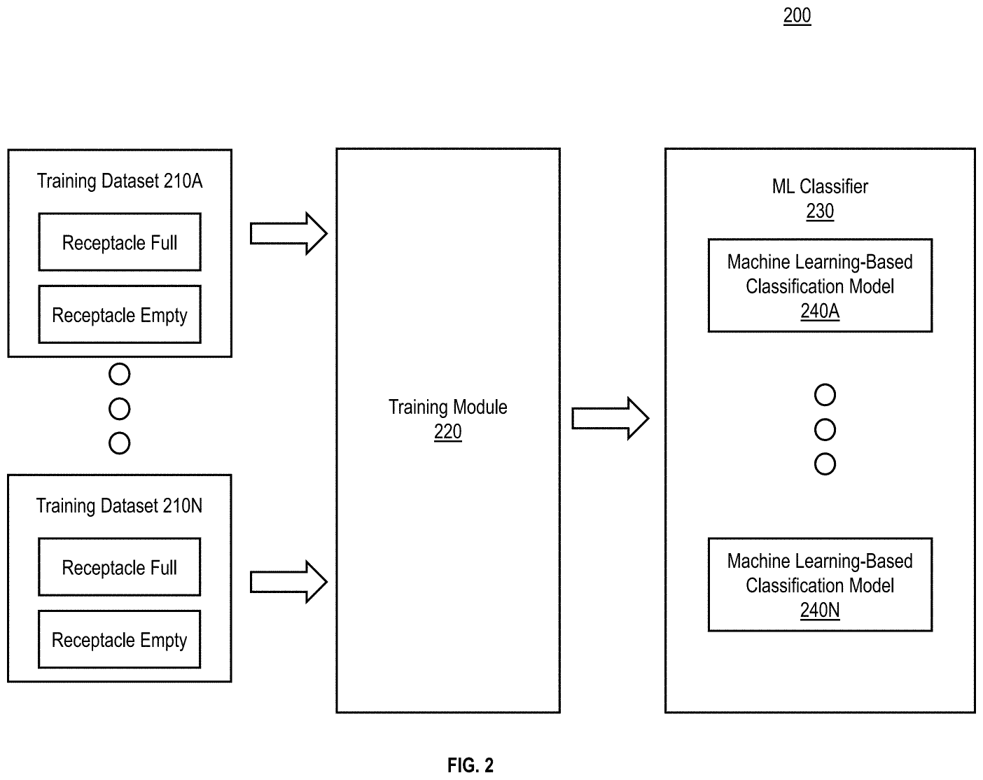

FIG. 2 is an example system 200 for training the imaging module 104 to manage the dispensement of fluid to receptacle 109, according to some embodiments. FIG. 2 is described with reference to FIG. 1. According to some aspects, the imaging module 104 may be trained to determine a empty fluid state of a receptacle (e.g., the receptacle 109, etc.) or a full fluid state for the receptacle. For example, the imaging module 104 may classify a receptacle (e.g., the receptacle 109, etc.) as being an empty cup or full cup. According to some aspects, the imaging module 104 may be trained to determine as a fill line (e.g., the fill line 108 of FIG. 1, etc.) of a receptacle (e.g., the receptacle 109, etc.). According to some aspects, the imaging module 104 may be trained to determine the amount and/or position of fluid (e.g., the fluid 107 of FIG. 1, etc.) dispensed to a receptacle, for example, by a beverage dispensing nozzle (e.g., the beverage dispensing nozzle 106 of FIG. 1, etc.). The system 200 may use machine learning techniques to train, based on an analysis of one or more training datasets 210A-210N by the imaging module 104 of FIG. 1, at least one machine learning-based classifier 230 (e.g., a software model, neural network classification layer, etc.) that is configured to classify features extracted from imaging data, for example, such as imaging data received from the camera 105 of FIG. 1. The machine learning-based classifier 230 may classify features extracted from imaging data to identify a receptacle and determine information about the receptacle such as an empty state of the receptacle, a full state of the receptacle. According to some aspects, the machine learning-based classifier 230 may classify features extracted from imaging data to identify a receptacle and determine a fill capacity threshold and/or an amount of fluid within the receptacle (e.g., whether the amount of fluid in the receptacle satisfies a fill level threshold, etc.).

The one or more training datasets 210A-210N may comprise labeled baseline data such as labeled receptacle types (e.g., various shaped cups, bottles, cans, bowls, boxes, etc.), labeled receptacle scenarios (e.g., receptacles with ice, receptacles without ice, empty receptacles, full receptacles, receptacles containing varying amounts of fluid, receptacles comprising straws and/or other objects, etc.), labeled receptacle capacities (e.g., fill line thresholds for receptacles, indications of the amount of fluid various receptacles can hold, etc.), labeled fluid types (e.g., beverage types, water, juices, etc.), labeled fluid behaviors (e.g., indications of carbonation, indications of viscosity, etc.). The labeled baseline data may include any number of feature sets (labeled data that identifies extracted features from imaging data, etc.).

The labeled baseline data may be stored in one or more databases. Data (e.g., imaging data, etc.) for managing receptacle autofill detection and fluid dispenser operations may be randomly assigned to a training dataset or a testing dataset. According to some aspects, the assignment of data to a training dataset or a testing dataset may not be completely random. In this case, one or more criteria may be used during the assignment, such as ensuring that similar receptacle types, similar receptacle scenarios, similar receptacle capacities, similar fluid types, similar fluid behaviors, dissimilar receptacle types, dissimilar receptacle scenarios, dissimilar receptacle capacities, dissimilar fluid types, dissimilar fluid behaviors, and/or the like may be used in each of the training and testing datasets. In general, any suitable method may be used to assign the data to the training or testing datasets.

The imaging module 104 may train the machine learning-based classifier 230 by extracting a feature set from the labeled baseline data according to one or more feature selection techniques. According to some aspects, the imaging module 104 may further define the feature set obtained from the labeled baseline data by applying one or more feature selection techniques to the labeled baseline data in the one or more training datasets 210A-210N. The imaging module 104 may extract a feature set from the training datasets 210A-210N in a variety of ways. The imaging module 104 may perform feature extraction multiple times, each time using a different feature-extraction technique. In some instances, the feature sets generated using the different techniques may each be used to generate different machine learning-based classification models 240. According to some aspects, the feature set with the highest quality metrics may be selected for use in training. The imaging module 104 may use the feature set(s) to build one or more machine learning-based classification models 240A-240N that are configured to determine and/or predict receptacle types, receptacle scenarios, receptacle capacities, fluid types, fluid behaviors, and/or the like.

According to some aspects, the training datasets 210A-210N and/or the labeled baseline data may be analyzed to determine any dependencies, associations, and/or correlations between receptacle types, receptacle scenarios, receptacle capacities, fluid types, fluid behaviors, and/or the like in the training datasets 210A-210N and/or the labeled baseline data. The term “feature,” as used herein, may refer to any characteristic of an item of data that may be used to determine whether the item of data falls within one or more specific categories. For example, the features described herein may comprise receptacle types, receptacle scenarios, receptacle capacities, fluid types, fluid behaviors, and/or any other characteristics.

According to some aspects, a feature selection technique may comprise one or more feature selection rules. The one or more feature selection rules may comprise determining which features in the labeled baseline data appear over a threshold number of times in the labeled baseline data and identifying those features that satisfy the threshold as candidate features. For example, any features that appear greater than or equal to 2 times in the labeled baseline data may be considered as candidate features. Any features appearing less than 2 times may be excluded from consideration as a feature. According to some aspects, a single feature selection rule may be applied to select features or multiple feature selection rules may be applied to select features. According to some aspects, the feature selection rules may be applied in a cascading fashion, with the feature selection rules being applied in a specific order and applied to the results of the previous rule. For example, the feature selection rule may be applied to the labeled baseline data to generate information (e.g., an indication of a receptacle type, an indication of a receptacle scenario, an indication of a receptacle capacity, an indication of a fluid type, an indication of fluid behavior, etc.) that may be used for receptacle autofill operations for a fluid dispenser. A final list of candidate features may be analyzed according to additional features.

According to some aspects, the imaging module 104 may generate information (e.g., an indication of a receptacle type, an indication of a receptacle scenario, an indication of a receptacle capacity, an indication of a fluid type, an indication of fluid behavior, etc.) that may be used for receptacle autofill operations for a fluid dispenser may be based a wrapper method. A wrapper method may be configured to use a subset of features and train the machine learning model using the subset of features. Based on the inferences that are drawn from a previous model, features may be added and/or deleted from the subset. Wrapper methods include, for example, forward feature selection, backward feature elimination, recursive feature elimination, combinations thereof, and the like. According to some aspects, forward feature selection may be used to identify one or more candidate receptacle types, receptacle scenarios, receptacle capacities, fluid types, fluid behaviors, and/or the like. Forward feature selection is an iterative method that begins with no feature in the machine learning model. In each iteration, the feature which best improves the model is added until the addition of a new variable does not improve the performance of the machine learning model. According to some aspects, backward elimination may be used to identify one or more candidate receptacle types, receptacle scenarios, receptacle capacities, fluid types, fluid behaviors, and/or the like. Backward elimination is an iterative method that begins with all features in the machine learning model. In each iteration, the least significant feature is removed until no improvement is observed on the removal of features. According to some aspects, recursive feature elimination may be used to identify one or more candidate receptacle types, receptacle scenarios, receptacle capacities, fluid types, fluid behaviors, and/or the like. Recursive feature elimination is a greedy optimization algorithm that aims to find the best performing feature subset. Recursive feature elimination repeatedly creates models and keeps aside the best or the worst performing feature at each iteration. Recursive feature elimination constructs the next model with the features remaining until all the features are exhausted. Recursive feature elimination then ranks the features based on the order of their elimination.

According to some aspects, one or more candidate receptacle types, receptacle scenarios, receptacle capacities, fluid types, fluid behaviors, and/or the like may be determined according to an embedded method. Embedded methods combine the qualities of filter and wrapper methods. Embedded methods include, for example, Least Absolute Shrinkage and Selection Operator (LASSO) and ridge regression which implement penalization functions to reduce overfitting. For example, LASSO regression performs L1 regularization which adds a penalty equivalent to an absolute value of the magnitude of coefficients and ridge regression performs L2 regularization which adds a penalty equivalent to the square of the magnitude of coefficients.

After imaging module 104 generates a feature set(s), the imaging module 104 may generate a machine learning-based predictive model 240 based on the feature set(s). Machine learning-based predictive model may refer to a complex mathematical model for data classification that is generated using machine-learning techniques. For example, this machine learning-based classifier may include a map of support vectors that represent boundary features. By way of example, boundary features may be selected from, and/or represent the highest-ranked features in, a feature set.

According to some aspects, the imaging module 104 may use the feature sets extracted from the training datasets 210A-210N and/or the labeled baseline data to build a machine learning-based classification model 240A-240N to determine and/or predict receptacle types, receptacle scenarios, receptacle capacities, fluid types, fluid behaviors, and/or the like. According to some aspects, the machine learning-based classification models 240A-240N may be combined into a single machine learning-based classification model 240. Similarly, the machine learning-based classifier 230 may represent a single classifier containing a single or a plurality of machine learning-based classification models 240 and/or multiple classifiers containing a single or a plurality of machine learning-based classification models 240. According to some aspects, the machine learning-based classifier 230 may also include each of the training datasets 210A-210N and/or each feature set extracted from the training datasets 210A-210N and/or extracted from the labeled baseline data. Although shown separately, imaging module 104 may include the machine learning-based classifier 230.

The extracted features from the imaging data may be combined in a classification model trained using a machine learning approach such as discriminant analysis; decision tree; a nearest neighbor (NN) algorithm (e.g., k-NN models, replicator NN models, etc.); statistical algorithm (e.g., Bayesian networks, etc.); clustering algorithm (e.g., k-means, mean-shift, etc.); neural networks (e.g., reservoir networks, artificial neural networks, etc.); support vector machines (SVMs); logistic regression algorithms; linear regression algorithms; Markov models or chains; principal component analysis (PCA) (e.g., for linear models); multi-layer perceptron (MLP) ANNs (e.g., for non-linear models); replicating reservoir networks (e.g., for non-linear models, typically for time series); random forest classification; a combination thereof and/or the like. The resulting machine learning-based classifier 230 may comprise a decision rule or a mapping that uses imaging data to determine and/or predict receptacle types, receptacle scenarios, receptacle capacities, fluid types, fluid behaviors, and/or the like.

The imaging data and the machine learning-based classifier 230 may be used to determine and/or predict receptacle types, receptacle scenarios, receptacle capacities, fluid types, fluid behaviors, and/or the like for the test samples in the test dataset. For example, the result for each test sample may include a confidence level that corresponds to a likelihood or a probability that the corresponding test sample accurately determines and/or predicts receptacle types, receptacle scenarios, receptacle capacities, fluid types, fluid behaviors, and/or the like. The confidence level may be a value between zero and one that represents a likelihood that the determined/predicted receptacle type, receptacle scenario, receptacle capacity, fluid type, fluid behavior, and/or the like is consistent with a computed value. Multiple confidence levels may be provided for each test sample and each candidate (approximated) receptacle type, receptacle scenario, receptacle capacity, fluid type, fluid behavior, and/or the like. A top-performing candidate receptacle type, receptacle scenario, receptacle capacity, fluid type, fluid behavior, and/or the like may be determined by comparing the result obtained for each test sample with a computed receptacle type, receptacle scenario, receptacle capacity, fluid type, fluid behavior, and/or the like for each test sample. In general, the top-performing candidate receptacle type, receptacle scenario, receptacle capacity, fluid type, fluid behavior, and/or the like will have results that closely match the computed receptacle type, receptacle scenario, receptacle capacity, fluid type, fluid behavior, and/or the like. The top-performing candidate receptacle types, receptacle scenarios, receptacle capacities, fluid types, fluid behaviors, and/or the like may be used for managing receptacle autofill detection and fluid dispenser operations.

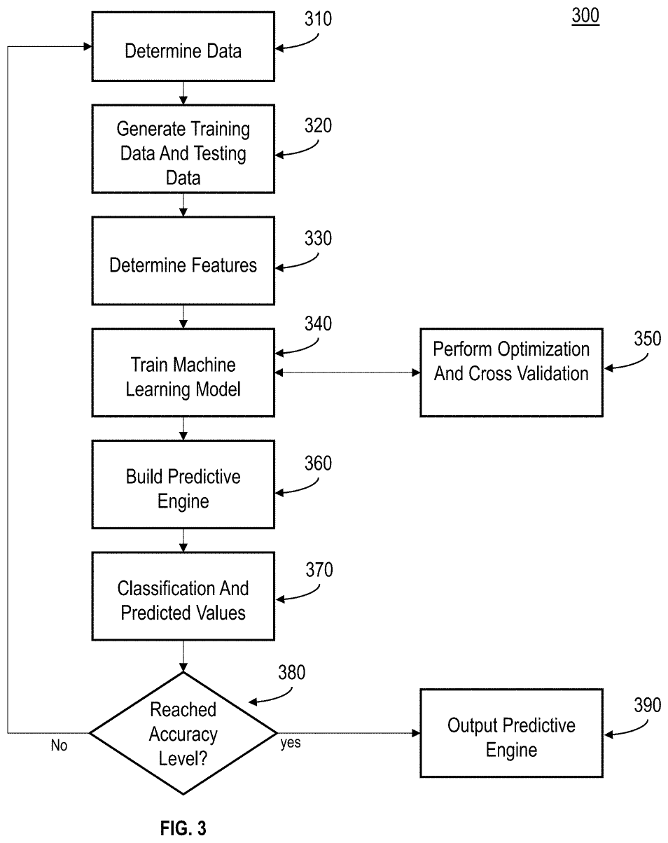

FIG. 3 is a flowchart illustrating an example training method 300 for generating the machine learning classifier 230 using the imaging module 104, according to some aspects. The imaging module 104 can implement supervised, unsupervised, and/or semi-supervised (e.g., reinforcement-based) machine learning-based classification models 240. The method 300 shown in FIG. 3 is an example of a supervised learning method; variations of this example of training method are discussed below, however, other training methods can be analogously implemented to train unsupervised and/or semi-supervised machine learning (predictive) models. Method 300 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 3, as will be understood by a person of ordinary skill in the art.

Method 300 shall be described with reference to FIGS. 1 and 2. However, method 300 is not limited to the aspects of those figures.

In 310, imaging module 104 determines (e.g., access, receive, retrieve, etc.) imaging data. Imaging data may contain one or more datasets, each dataset associated with a receptacle type, receptacle scenario, receptacle capacity, fluid type, fluid behavior, and/or the like.

In 320, imaging module 104 generates a training dataset and a testing dataset. According to some aspects, the training dataset and the testing dataset may be generated by indicating a receptacle type, receptacle scenario, receptacle capacity, fluid type, fluid behavior, and/or the like. According to some aspects, the training dataset and the testing dataset may be generated by randomly assigning a receptacle type, receptacle scenario, receptacle capacity, fluid type, fluid behavior, and/or the like to either the training dataset or the testing dataset. According to some aspects, the assignment of imaging data as training or test samples may not be completely random. According to some aspects, only the labeled baseline data for a specific feature extracted from specific imaging data (e.g., depictions of a clear cup with ice, etc.) may be used to generate the training dataset and the testing dataset. According to some aspects, a majority of the labeled baseline data extracted from imaging data may be used to generate the training dataset. For example, 75% of the labeled baseline data for determining a receptacle type, receptacle scenario, receptacle capacity, fluid type, fluid behavior, and/or the like extracted from the imaging data may be used to generate the training dataset and 25% may be used to generate the testing dataset. Any method or technique may be used to create the training and testing datasets.

In 330, imaging module 104 determines (e.g., extract, select, etc.) one or more features that can be used by, for example, a classifier (e.g., a software model, a classification layer of a neural network, etc.) to label features extracted from a variety of imaging data. One or more features may comprise indications of a receptacle type, receptacle scenario, receptacle capacity, fluid type, fluid behavior, and/or the like. According to some aspects, the imaging module 104 may determine a set of training baseline features from the training dataset. Features of imaging data may be determined by any method.

In 340, imaging module 104 trains one or more machine learning models, for example, using the one or more features. According to some aspects, the machine learning models may be trained using supervised learning. According to some aspects, other machine learning techniques may be employed, including unsupervised learning and semi-supervised. The machine learning models trained in 340 may be selected based on different criteria (e.g., how close a predicted receptacle type, receptacle scenario, receptacle capacity, fluid type, fluid behavior, and/or the like is to an actual receptacle type, receptacle scenario, receptacle capacity, fluid type, fluid behavior, and/or the like) and/or data available in the training dataset. For example, machine learning classifiers can suffer from different degrees of bias. According to some aspects, more than one machine learning model can be trained.

In 350, imaging module 104 optimizes, improves, and/or cross-validates trained machine learning models. For example, data for training datasets and/or testing datasets may be updated and/or revised to include more labeled data indicating different receptacle types, receptacle scenarios, receptacle capacities, fluid types, fluid behaviors, and/or the like.

In 360, imaging module 104 selects one or more machine learning models to build a predictive model (e.g., a machine learning classifier, a predictive engine, etc.). The predictive model may be evaluated using the testing dataset.

In 370, imaging module 104 executes the predictive model to analyze the testing dataset and generate classification values and/or predicted values.

In 380, imaging module 104 evaluates classification values and/or predicted values output by the predictive model to determine whether such values have achieved the desired accuracy level. Performance of the predictive model may be evaluated in a number of ways based on a number of true positives, false positives, true negatives, and/or false negatives classifications of the plurality of data points indicated by the predictive model. For example, the false positives of the predictive model may refer to the number of times the predictive model incorrectly predicted and/or determined a receptacle type, receptacle scenario, receptacle capacity, fluid type, fluid behavior, and/or the like. Conversely, the false negatives of the predictive model may refer to the number of times the machine learning model predicted and/or determined a receptacle type, receptacle scenario, receptacle capacity, fluid type, fluid behavior, and/or the like incorrectly, when in fact, the predicted and/or determined a receptacle type, receptacle scenario, receptacle capacity, fluid type, fluid behavior, and/or the like matches an actual receptacle type, receptacle scenario, receptacle capacity, fluid type, fluid behavior, and/or the like. True negatives and true positives may refer to the number of times the predictive model correctly predicted and/or determined a receptacle type, receptacle scenario, receptacle capacity, fluid type, fluid behavior, and/or the like. Related to these measurements are the concepts of recall and precision. Generally, recall refers to a ratio of true positives to a sum of true positives and false negatives, which quantifies the sensitivity of the predictive model. Similarly, precision refers to a ratio of true positives as a sum of true and false positives.

In 390, imaging module 104 outputs the predictive model (and/or an output of the predictive model). For example, imaging module 104 may output the predictive model when such a desired accuracy level is reached. An output of the predictive model may end the training phase.

According to some aspects, when the desired accuracy level is not reached, in 390, imaging module 104 may perform a subsequent iteration of the training method 300 starting at 310 with variations such as, for example, considering a larger collection of imaging data.

Returning to FIG. 1, an output of the imaging module 104, for example, a determination of a receptacle type, receptacle scenario, receptacle capacity, fluid type, fluid behavior, and/or the like, may be provided to a fluid control module 110 of the computing device 103. For example, the fluid control module 110 may receive an indication from the imaging module 104 that the receptacle 109 is below the beverage dispensing nozzle 106. According to some aspects, for example, to conserve energy and/or resources, the fluid dispenser 101 may be in an inactive state or transition to an inactive state when idle. When the fluid control module 110 receives an indication from the imaging module 104 that the receptacle 109 is below the beverage dispensing nozzle 106, the fluid control module 110 may send a signal to the fluid dispenser 101 that causes the fluid dispenser 101 to transition from an inactive state to an active state. For example, in an active state, the fluid dispenser 101 may begin to rapidly cool and/or heat fluids within the fluid dispenser 101 in preparation for consumption.

According to some aspects, the imaging module 104 may determine a state of the receptacle 109. The imaging module 104 may determine, from imaging data, that an image (e.g., a frame of video, etc.) indicates that the receptacle 109 is in an empty fluid state (e.g., dos not contain fluid, only contains ice, etc.). The imaging module 104 may send the indication that the receptacle 109 is in an empty fluid state to the fluid control module 110. The fluid control module 110 may send one or more signals (e.g., transmissions, requests, data, etc.) that control operations of the pour unit 102 to cause fluid to be dispensed from the beverage dispensing nozzle 106. The imaging module 104 may continue to monitor imaging data (from the camera 105) for an indication that the receptacle 109 is in a full fluid state. When the imaging module 104 determines the receptacle 109 is in a full fluid state (or will reach the full fluid state within a timewindow, etc.), the imaging module 104 may send the indication that the receptacle 109 is in the full fluid state to the fluid control module 110. The fluid control module 110 may send one or more signals (e.g., transmissions, requests, data, etc.) that control operations of the pour unit 102 to stop causing fluid to be dispensed from the beverage dispensing nozzle 106.

According to some aspects, the imaging module 104 may determine a fill level threshold, for example, the fill line 108 (e.g., an indication of available fluid capacity, etc.) of the receptacle 109. The imaging module 104 may determine, from imaging data, that an image (e.g., a frame of video, etc.) indicates that an amount of fluid in the receptacle 109 does not satisfy the fill level threshold. The imaging module 104 may send the indication that the amount of fluid in the receptacle 109 does not satisfy the fill level threshold to the fluid control module 110. The fluid control module 110 may send one or more signals (e.g., transmissions, requests, data, etc.) that control operations of the pour unit 102 to cause fluid to be dispensed from the beverage dispensing nozzle 106. The imaging module 104 may continue to monitor imaging data (from the camera 105) for an indication that the amount of fluid in the receptacle 109 satisfies the fill level threshold. When the imaging module 104 determines that the amount of fluid in the receptacle 109 satisfies the fill level threshold, the imaging module 104 may send the indication that the amount of fluid in the receptacle 109 satisfies (or is about to satisfy) the fill level threshold to the fluid control module 110. The fluid control module 110 may send one or more signals (e.g., transmissions, requests, data, etc.) that control operations of the pour unit 102 to stop causing fluid to be dispensed from the beverage dispensing nozzle 106.

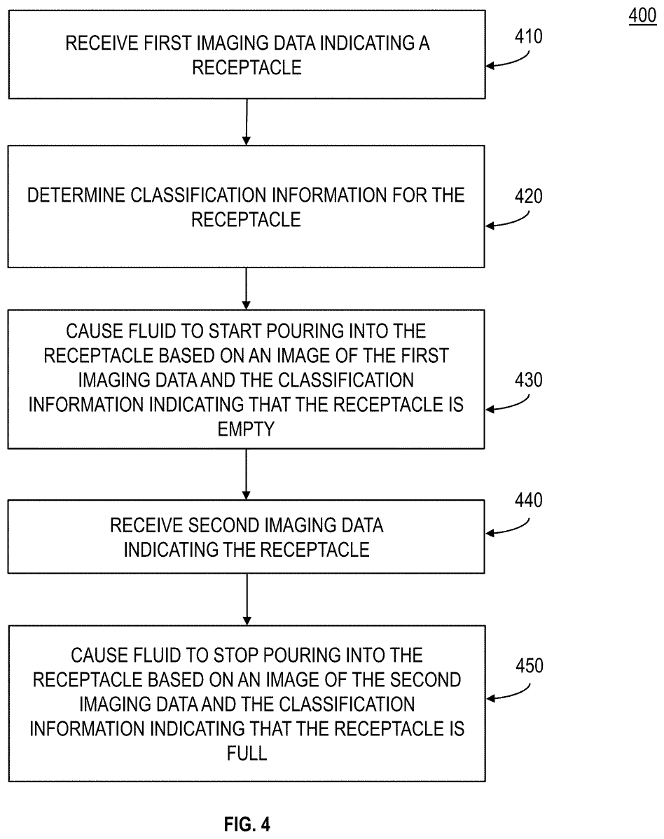

FIG. 4 shows a flowchart of an example method 400 for the dispensement of fluid to a receptacle, according to some aspects. Method 400 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 4, as will be understood by a person of ordinary skill in the art.

Method 400 shall be described with reference to FIGS. 1-2. However, method 400 is not limited to is not limited to the aspects of those figures.

A computer-based system (e.g., the system 100, etc.) may facilitate automated dispensing of fluid to a receptacle based on imaging data collected by a camera positioned near a beverage dispensing nozzle of a fluid dispenser .

In 410, system 100 (e.g., the computing device 103, etc.) receives first imaging data. The system 100 may receive the first imaging data from a camera and/or the like placed/positioned in proximity to the nozzle of a fluid dispenser (e.g., a beverage dispenser, a water dispenser, a fountain drink machine, etc.). The first imaging data may include video and/or static images. The first imaging data may indicate a receptacle. For example, the first imaging data may include an image of a receptacle (e.g., a cup, a bottle, a can, a bowl, a box, etc.) placed/positioned beneath the nozzle of the fluid dispenser.

In 420, system 100 determines classification information for the receptacle. For example, a predictive model (and/or predictive engine) of the computer-based system may be configured to determine the classification information for the receptacle. For example, determining the classification information for the receptacle may be based on image recognition and/or object recognition applied to the first imaging data. Image recognition and/or object recognition may be used to determine a empty state (e.g., an empty fluid state, etc.) for the receptacle or a full state (e.g., a full fluid state, etc.) for the receptacle.

In 430, system 100 causes fluid to start pouring into the receptacle. The computer-based system may cause fluid to start pouring into the receptacle based on an image of the first imaging data and the classification information indicating that the receptacle is in the empty state. According to some aspects, the predictive model may be configured to determine that the image of the first imaging data indicates that the the receptacle is in an empty state. For example, the system 100 may input, into the predictive model, the first imaging data. The system 100 may execute, based on the first imaging data, the predictive model. The system 100 may receive, based on executing the predictive model, the classification information for the receptacle and/or the indication that the receptacle is in the empty state. Causing the fluid to start pouring into the receptacle may include, for example, sending, to a pouring device, a request to start pouring the fluid into the receptacle. The pouring device may be configured to dispense a plurality of fluids.

In 440, system 100 receives second imaging data. The system 100 may receive the second imaging data from the camera and/or the like placed/positioned in proximity to the nozzle of the fluid dispenser. The second imaging data may indicate the receptacle. The first imaging data and the second imaging data may be part of a video stream and/or the like captured by the the camera and/or the like placed/positioned in proximity to the nozzle of the fluid dispenser.

In 450, system 100 causes fluid to stop pouring into the receptacle. The system 100 may cause fluid to stop pouring into the receptacle based on an image of the second imaging data and the classification information indicating that the receptacle is in the full state. According to some aspects, the predictive model may be configured to determine that the image of the second imaging data indicates that the receptacle is in the full state. For example, the system 100 may input, into the predictive model, the imaging data. The system 100 may execute, based on the imaging data, the predictive model. The system 100 may receive, based on executing the predictive model, the classification information for the receptacle and/or the indication that the receptacle is in the full state. Causing the fluid to stop pouring into the receptacle may include, for example, sending, to the pouring device, a request to stop pouring the fluid into the receptacle. According to some aspects, causing the fluid to stop pouring into the receptacle may cause the pouring device to transition to an inactive state.

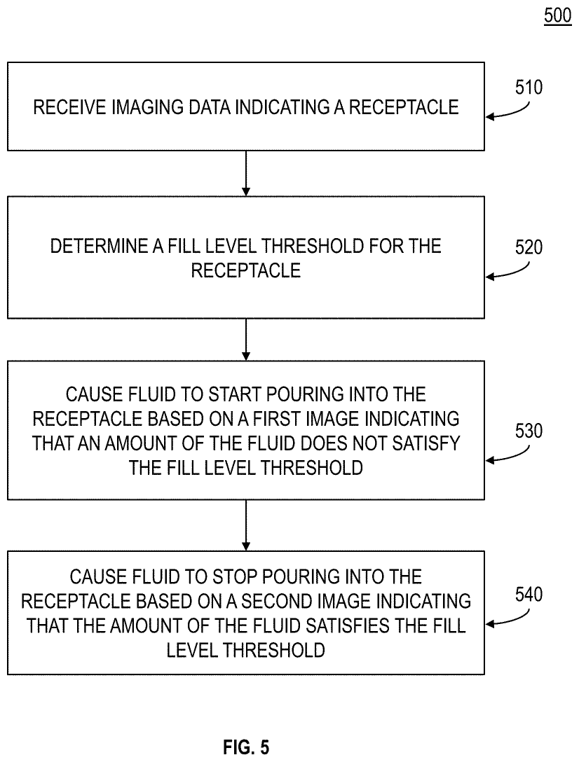

FIG. 5 shows a flowchart of an example method 500 for the dispensement of fluid to a receptacle, according to some aspects. Method 500 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 5, as will be understood by a person of ordinary skill in the art.

Method 500 shall be described with reference to FIGS. 1-2. However, method 500 is not limited to is not limited to the aspects of those figures.

A computer-based system (e.g., the system 100, etc.) may facilitate automated dispensing of fluid to a receptacle based on imaging data collected by a camera positioned near a beverage dispensing nozzle of a fluid dispenser .

In 510, system 100 (e.g., the computing device 103, etc.) receives imaging data. The system 100 may receive the imaging data from a camera and/or the like placed/positioned in proximity to the nozzle of a fluid dispenser (e.g., a beverage dispenser, a water dispenser, a fountain drink machine, etc.). The imaging data may include video and/or static images. The imaging data may indicate a receptacle. For example, the imaging data may include an image of a receptacle (e.g., a cup, a bottle, a can, a bowl, a box, etc.) placed/positioned beneath the nozzle of the fluid dispenser.

In 420, system 100 determines a fill level threshold for the receptacle. For example, a predictive model (and/or predictive engine) of the computer-based system may be configured to determine the fill level threshold for the receptacle. For example, determining the fill level threshold for the receptacle may include determining, based on object recognition, a type of the receptacle. Based on the type of the receptacle, fill level threshold classification information may be determined. Based on the fill level threshold classification information, the fill level threshold for the receptacle may be determined.

In 530, system 100 causes fluid to start pouring into the receptacle. The computer-based system may cause fluid to start pouring into the receptacle based on a first image of the imaging data indicating that an amount of fluid in the receptacle does not satisfy the fill level threshold. According to some aspects, the predictive model may be configured to determine that the first image indicates that the amount of fluid in the receptacle does not satisfy (e.g., is is less than the threshold, etc.) the fill level threshold. For example, the system 100 may input, into the predictive model, the imaging data. The system 100 may execute, based on the imaging data, the predictive model. The system 100 may receive, based on executing the predictive model, an indication that the first image indicates that the amount of fluid in the receptacle is less than the fill level threshold. Causing the fluid to start pouring into the receptacle may include, for example, sending, to a pouring device, a request to start pouring the fluid into the receptacle. The pouring device may be configured to dispense a plurality of fluids.

In 540, system 100 causes fluid to stop pouring into the receptacle. The computer-based system may cause fluid to stop pouring into the receptacle based on a second image of the imaging data indicating that an amount of fluid in the receptacle satisfies the fill level threshold. According to some aspects, the predictive model may be configured to determine that the second image indicates that the amount of fluid in the receptacle satisfies (e.g., is equal to the threshold, exceeds the threshold, etc.) the fill level threshold. For example, the system 100 may input, into the predictive model, the imaging data. The system 100 may execute, based on the imaging data, the predictive model. The system 100 may receive, based on executing the predictive model, an indication that the second image indicates that the amount of fluid in the receptacle is equal to the fill level threshold. Causing the fluid to stop pouring into the receptacle may include, for example, sending, to the pouring device, a request to stop pouring the fluid into the receptacle. According to some aspects, causing the fluid to stop pouring into the receptacle may cause the pouring device to transition to an inactive state.

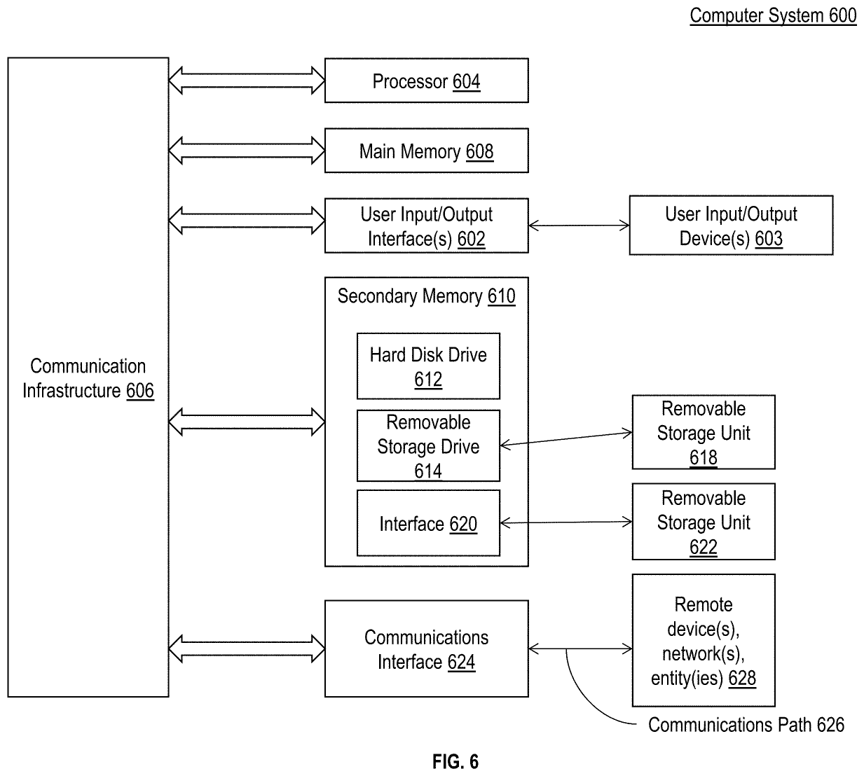

FIG. 6 is an example computer system useful for implementing various embodiments. Various embodiments may be implemented, for example, using one or more well-known computer systems, such as computer system 600 shown in FIG. 6. One or more computer systems 600 may be used, for example, to implement any of the embodiments discussed herein, as well as combinations and sub-combinations thereof. According to some aspects, the computing device 103 of FIG. 1 (and/or any other device/component described herein) may be implemented using the computer system 600. According to some aspects, the computer system 600 may be used to implement methods 300, 400, and 500.

Computer system 600 may include one or more processors (also called central processing units, or CPUs), such as a processor 604. Processor 604 may be connected to a communication infrastructure or bus 606.

Computer system 600 may also include user input/output device(s) 602, such as monitors, keyboards, pointing devices, etc., which may communicate with communication infrastructure or bus 606 through user input/output device(s) 602.

One or more of processors 604 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 600 may also include a main or primary memory 608, such as random access memory (RAM). Main memory 608 may include one or more levels of cache. Main memory 608 may have stored therein control logic (i.e., computer software) and/or data.

Computer system 600 may also include one or more secondary storage devices or memory 610. Secondary memory 610 may include, for example, a hard disk drive 612 and/or a removable storage device or drive 614. Removable storage drive 614 may be a floppy disk drive, a magnetic tape drive, a compact disk drive, an optical storage device, a tape backup device, and/or any other storage device/drive.

Removable storage drive 614 may interact with a removable storage unit 618. The removable storage unit 618 may include a computer-usable or readable storage device having stored thereon computer software (control logic) and/or data. Removable storage unit 618 may be a floppy disk, magnetic tape, compact disk, DVD, optical storage disk, and/ any other computer data storage device. Removable storage drive 614 may read from and/or write to the removable storage unit 618.

Secondary memory 610 may include other means, devices, components, instrumentalities, and/or other approaches for allowing computer programs and/or other instructions and/or data to be accessed by computer system 600. Such means, devices, components, instrumentalities, and/or other approaches may include, for example, a removable storage unit 622 and an interface 620. Examples of the removable storage unit 622 and the interface 620 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 600 may further include a communication or network interface 624. Communication interface 624 may enable computer system 600 to communicate and interact with any combination of external devices, external networks, external entities, etc. (individually and collectively referenced by reference number 628). For example, communication interface 624 may allow computer system 600 to communicate with external or remote devices 628 over communications path 626, which may be wired and/or wireless (or a combination thereof), and which may include any combination of LANs, WANs, the Internet, etc. Control logic and/or data may be transmitted to and from computer system 600 via communication path 626.

Computer system 600 may also be any of a personal digital assistant (PDA), desktop workstation, laptop or notebook computer, netbook, tablet, smartphone, smartwatch or other wearables, appliance, part of the Internet-of-Things, and/or embedded system, to name a few non-limiting examples, or any combination thereof.

Computer system 600 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 600 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats, and/or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 600, main memory 608, secondary memory 610, and removable storage units 618 and 622, as well as tangible articles of manufacture embodying any combination of the foregoing. Such control logic, when executed by one or more data processing devices (such as computer system 600), may cause such data processing devices to operate as described herein.

Based on the teachings contained in this disclosure, it will be apparent to persons skilled in the relevant art(s) how to make and use embodiments of this disclosure using data processing devices, computer systems, and/or computer architectures other than that shown in FIG. 6. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

Additionally and/or alternatively, while this disclosure describes exemplary embodiments for exemplary fields and applications, it should be understood that the disclosure is not limited thereto. Other embodiments and modifications thereto are possible and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

implementation One or more parts of the above implementations may include software. Software is a general term whose meaning of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method for dispensing fluid into a receptacle, the method comprising:
receiving first imaging data, wherein the first imaging data indicates a receptacle;
determining, based on the first imaging data, classification information for the receptacle, wherein the classification information classifies an empty state for the receptacle and a full state for the receptacle;
causing, based on an image of the first imaging data and the classification information indicating that the receptacle is in the empty state, fluid to start pouring into the receptacle;
receiving second imaging data, wherein the second imaging data indicates the receptacle; and
causing, based on an image of the second imaging data and the classification information indicating that the receptacle is in the full state, the fluid to stop pouring into the receptacle.

2. The method of claim 1, wherein the determining the classification information for the receptacle is based on at least one of object recognition or image recognition.

3. The method of claim 1, wherein the causing the fluid to start pouring into the receptacle further comprises:
sending, to a pouring device, a request to start pouring the fluid into the receptacle, wherein the pouring device is configured to dispense a plurality of fluids.

4. The method of claim 1, wherein the causing the fluid to stop pouring into the receptacle further comprises:
sending, to a pouring device, a request to stop pouring the fluid into the receptacle, wherein the pouring device is configured to dispense a plurality of fluids.

5. The method of claim 4, further comprising:
causing the pouring device to transition to an inactive state in response to causing the fluid to stop pouring into the receptacle.

6. The method of claim 1, further comprising:
inputting, into a predictive model, the first imaging data;
executing, based on the first imaging data, the predictive model; and
receiving, based on the classification information for the receptacle, the indication that the receptacle is in the empty state.

7. The method of claim 1, further comprising:
inputting, into a predictive model, the second imaging data;
executing, based on the second imaging data, the predictive model; and
receiving, based on the classification information for the receptacle, the indication that the receptacle is in the full state.

8. A non-transitory computer-readable medium having instructions stored thereon that, when executed by at least one computing device, cause the at least one computing device to perform operations comprising:
receiving first imaging data, wherein the first imaging data indicates a receptacle;
determining, based on the first imaging data, classification information for the receptacle, wherein the classification information classifies an empty state for the receptacle and a full state for the receptacle;
causing, based on an image of the first imaging data and the classification information indicating that the receptacle is in the empty state, fluid to start pouring into the receptacle;
receiving second imaging data, wherein the second imaging data indicates the receptacle; and
causing, based on an image of the second imaging data and the classification information indicating that the receptacle is in the full state, the fluid to stop pouring into the receptacle.

9. The non-transitory computer-readable medium of claim 8, wherein the determining the classification information for the receptacle is based on at least one of object recognition or image recognition.

10. The non-transitory computer-readable medium of claim 8, wherein the causing the fluid to start pouring into the receptacle further comprises:
sending, to a pouring device, a request to start pouring the fluid into the receptacle, wherein the pouring device is configured to dispense a plurality of fluids.

11. The non-transitory computer-readable medium of claim 8, wherein the causing the fluid to stop pouring into the receptacle further comprises:
sending, to a pouring device, a request to stop pouring the fluid into the receptacle, wherein the pouring device is configured to dispense a plurality of fluids.

12. The non-transitory computer-readable medium of claim 11, further comprising:
causing the pouring device to transition to an inactive state in response to causing the fluid to stop pouring into the receptacle.

13. The non-transitory computer-readable medium of claim 8, further comprising:
inputting, into a predictive model, the first imaging data;
executing, based on the first imaging data, the predictive model; and
receiving, based on the classification information for the receptacle, the indication that the receptacle is in the empty state.

14. The non-transitory computer-readable medium of claim 8, further comprising:
inputting, into a predictive model, the second imaging data;
executing, based on the second imaging data, the predictive model; and
receiving, based on the classification information for the receptacle, the indication that the receptacle is in the full state.

15. A system for dispensing fluid into a receptacle, comprising:
a memory; and
at least one processor coupled to the memory and configured to:
receive first imaging data, wherein the first imaging data indicates the receptacle;
determine, based on the first imaging data, classification information for the receptacle, wherein the classification information classifies an empty state for the receptacle and a full state for the receptacle;
cause, based on an image of the first imaging data and the classification information indicating that the receptacle is in the empty state, fluid to start pouring into the receptacle;
receive second imaging data, wherein the second imaging data indicates the receptacle; and
cause, based on an image of the second imaging data and the classification information indicating that the receptacle is in the full state, the fluid to stop pouring into the receptacle.

16. The system of claim 15, wherein to determine the classification information for the receptacle, the at least one processor is further configured to determine the classification information for the receptacle based on object recognition.

17. The system of claim 15, wherein to cause the fluid to start pouring into the receptacle, the at least one processor is further configured to:
send, to a pouring device, a request to start pouring the fluid into the receptacle, wherein the pouring device is configured to dispense a plurality of fluids.

18. The system of claim 15, wherein to cause the fluid to stop pouring into the receptacle, the at least one processor is further configured to:
send, to a pouring device, a request to stop pouring the fluid into the receptacle, wherein the pouring device is configured to dispense a plurality of fluids.

19. The system of claim 15, wherein the at least one processor is further configured to:
input, into a predictive model, the first imaging data;
execute, based on the first imaging data, the predictive model; and
receive, based on the classification information for the receptacle, the indication that the receptacle is in the empty state.

20. The system of claim 15, wherein the at least one processor is further configured to:
input, into a predictive model, the second imaging data;
execute, based on the second imaging data, the predictive model; and
receive, based on the classification information for the receptacle, the indication that the receptacle is in the full state.
